(19) United States
(12) Patent Application Publication
(10) Pub. No.: US 2004/0264683 A1
(43) Pub. Date: Dec. 30, 2004

(54) Hybrid access networks and methods

(76) Inventor: Stephen Bye, Atlanta, GA (US)

Correspondence Address: MYERS BIGEL SIBLEY & SAJOVEC, PO BOX 37428, RALEIGH, NC, 27627, US

(21) Appl. No.: 10/609,994

(22) Filed: Jun. 30, 2003

(51) Int. Cl. H04M 1/00; H04M 9/00

(52) U.S. Cl. 379/402; 398/71

(57) ABSTRACT

Methods and systems for hybrid network access are provided. An analog fiber optic distribution system is provided from a central office to a remote location associated with customer premises. A central office node located at the central office is configured to transmit at least two of digital subscriber loop (DSL), cable television and/or wireless networking signals on the analog fiber optic distribution system and convert received transmissions from the analog fiber optic distribution system to the at least two of DSL, cable television and/or wireless networking signals. A remote node located at the remote location is configured to transmit at least two of wireless networking signals received from a wireless networking distribution antenna, cable television signals received from a cable television distribution system and/or DSL signals received from a copper distribution system to customer premises over the analog fiber optic distribution system and convert received transmissions from the analog fiber optic distribution system to the at least two of wireless networking signals, cable television signals and/or DSL signals.

### FIELD OF THE INVENTION

The present invention relates to communications systems and more particularly to communication systems between a central office and a remote location.

### BACKGROUND OF THE INVENTION

With increased use of the internet, there has come an increase in demand for high speed communications to customer premises. Local Exchange Carrier (LEC) telephony networks have evolved over a period of time and are the result of a long-term optimization of investment to support voice services, while cable networks have similarly evolved, although represent an optimization of investment to support broadcast video. These two networks and service providers have clashed in the high-speed data space with facilities based competition for customers. Conventionally, high speed connections have been provided by Local Exchange Carriers (LECs) through digital subscriber loop (DSL) services or cable systems through data-over-coax systems. One potential difficulty with providing high speed network access is that DSL services may be limited based on the distance from a central office to customer premises. Thus, the “last mile” of the access network to the customer premises may limit the speed or access to high speed networks.

To overcome the limitations of distance, LECs have utilized or are pursuing fiber optic distribution to provide high speed access to customers. In fact, many LECs have already made significant investments in the outside plant and the access network to support fiber-based facilities. In the past several years LECs have been upgrading the plant to support asynchronous DSL (ADSL) with some limited Support for very high data rate DSL (VDSL). The level of investment to provide high speed network access has been significant and continues to be demanding, particularly with U.S. operators reporting between 40 and 75% loop qualification rates.

For example, LECs have utilized fiber to the home or fiber to the curb (collectively FTTx) solutions, such as Full Service Access Network (FSAN), Asynchronous Transfer Mode Passive Optical Network (APON) (see e.g., ITU-T G.983.1, “Broadband Optical Access Systems based on Passive Optical Networks”) and Broadband Passive Optical Network (BPON) models. FTTx access networks have been considered as an option to support video, telephony and broadband Internet access, and may be the future architecture of LECs. A number of different options for supporting video in a LEC network have been proposed, one option for supporting video over FTTx network is using the Expansion Band (EB)(see e.g., ITU-T G.983.3, “A Broadband Optical Access System with Increased Service Capability by Wavelength Allocation”) supporting a CATV overlay with SCM (Sub-Carrier Multiplexing, see e.g., Cooper et al, “Video over BPON with Integrated VDSL”, Fujitsu Sci. Tech. J., Vol. 37, No. 1, June 2001). To date, these solutions may be cost prohibitive given the complexity of the technology and the cost of installation, actual deployment has been capital expenditure limited.

The financial prudence of operators and the practical and operational impact of deploying LEC access networks has led to a continued and gradual evolution of the network. The LEC access network is typically a combination of different technologies supporting copper-based telephony and in many cases ADSL from the CO or remote terminal in conjunction with limited deployments of FTTx.

The current network upgrades to support broadband Internet access do not necessitate a migration to FTTx and the challenge for LECs has been to cost effectively serve customers beyond the remote terminals and cabinets in a fiber-based feeder network. Currently, one solution to providing high speed network access is to deploy remote DSL Access Multiplexers (DSLAMs) or xDSL (e.g. ADSL, SHDSL, VDSL) modems in the next-generation digital loop carriers (NG-DLCs) at the remote terminal/cabinets. Such an arrangement is illustrated in FIG. 1.

As seen in FIG. 1, a synchronous optical network (SONET/SDH) and/or dense wavelength division multiplexing (D-WDM) network connects the central office to a remote cabinet associated with customer premises. An add/drop multiplexer (ADM) at the remote cabinet provides access to the SONET/SDH/D-WDM network to the DLC and a remote DSLAM. The remote DSLAM then provides DSL access to customer premises and can be accessed through an xDSL modem at the customer premises over the plain old telephone system (POTS) copper infrastructure.

As briefly mentioned above, FTTx access networks have long been considered as an option to support video as well as telephony and broadband Internet access and may be the future architecture of LECs, although to date these solutions appear to be cost prohibitive given the complexity of the technology and as such deployment has been limited. FIG. 1 also illustrates an FTTx system wherein the central office is connected to an optical networking unit (ONU) associated with the customer premises. As seen in FIG. 1, an optical line terminal (OLT) at the central office provides access to the fiber optic network. An ONU at the customer premises may provide access to the fiber optic network and a network termination (NT) may provide access for a video set top box (STB) a workstation and/or a telephone.

Finally, FIG. 1 illustrates conventional use of a DSLAM at the central office to provide ADSL to customer premises that are sufficiently proximate to the central office. However, as discussed above, the number of customers that are sufficiently proximate to the central office to provide acceptable ADSL service directly from the central office may be limited.

Systems have also been described for extending the range of DSL services. For example, published United States Patent Application No. 20020135844, entitled “SYSTEM AND METHOD FOR EXTENDING THE RANGE OF xDSL SERVICES,” published Sep. 26, 2002, describes a system for extending the range of xDSL services utilizing a fiber optic link.

TDM/SCMA technology has been evaluated as an option for the upstream connection between an ONU and OLT in A-PON/VDSL broadband access networks as an alternative to TDM/TDMA, the critical parameters being laser linearity and Relative Intensity Noise (RIN) (see Pousa et al, “BroadBandLoop The Portuguese Field Trial, A Fiber/Copper Experience”, Proc. Broadband Access Conference, October 1999).

In addition to high speed network access through telephone systems, cable television systems also may provide high speed network access. FIG. 2 illustrates a hybrid fiber/coax system (HFC) that may be utilized to provide video and data services to a customer premises. As seen in FIG. 2, a “head-end” of an HFC system may utilize a cable modem termination system (CMTS) to provide high speed internet access to subscribers. The CMTS communicates with an analog fiber system, such as a subcarrier multiplexed (SCM) system, through an RF/Optical transmitter/receiver. The analog fiber system is terminated proximate the customer premises by a fiber node that connects to a conventional coaxial cable plant to provide the “last mile” to the customer premises. A cable modem at the customer premises provides high speed access and a set top box (STB) provides video.

In contrast to the telecom-based evolution of the access network, the cable companies have a comparatively reduced level of complexity for equipment deployed remotely in the HFC plant. Furthermore, the HFC network from the customer premise to the head-end is an SCM based solution and is a shared access network. SCM technology has also been considered as an option to support long-haul optical transmission (see e.g., Hui et al, “10-Gbit/s SCM Fiber System Using Optical SSB Modulation”, IEEE Photonics Technology Letters”, Vol. 13, No. 8, August 2001).

As illustrated in FIGS. 1 and 2, historically, with Carrier Serving Architectures (CSA) (see Bellcore, “Telecommunications Transmission Engineering-Facilities”, 3^{rd} Ed., Vol 2., 1990) and with FTTx architectures, LECs have been pushing more and more complexity into the outside plant to support shortened copper loops, improving operations costs with fiber feeder networks, and attempting to upgrade the out-side plant to support higher bandwidth services. In parallel with this development, the complexity of the customer premise equipment and the equipment in the central office has also been increasing with significantly better processing functionality and storage capacity. Conversely, in a cable network supporting voice, video and data services, the concentration of technological complexity is in the head-end and the customer premise, with the level of equipment complexity in the outside plant being reduced to a minimum.

Hybrid Fiber Radio (HFR) (see e.g., ITU-R Rec. F. 1332, “Radio Frequency. Signal Transport Through Optical Fibers”, May 1999 and EURESCOM, Project P921, “SDR-HFR Techniques & Performance Parameters and their Possible Impact on the UTRA Interface”, 1999) and similar solutions (see e.g., US Patent Application No. 20020003645, “Mobile Communication Network System using Digital Optical Link”, January 2002) for access connectivity for 2G, 2.5G and 3G wireless base stations are also possible, whereby the base band and RF stages of a BTS/Node B can be geographically separated and connected via optical fiber. Typically the base stations (BTS/Node Bs) in GSM, CDMA and UMTS networks are deployed at cell sites and connected back to a central office to a BSC or RNC as illustrated in FIG. 3. With the HFR access connectivity, the base band stage found in the BTS or Node B (in UMTS) can be installed in the central office and only the RF stage, referred to as a Remote Antenna Unit (RAU) is installed at the cell site.

As briefly mentioned above, the challenge for service providers has been to cost effectively deliver the suite of services including voice, video and data across a common network telecom infrastructure, and extensive research and work has been undertaken to enable this utopian scenario. Efforts including ISDN, B-ISDN, PON, B-PON, FSAN, a more recent proposal referred to as Harmonics (see Geha et al, “Harmonics, a new concept in Broadband Access Architecture & Service Evolution”, exp, Vol. 2, No. 2, July 2002), and even HFC cable networks have each been candidates for a convergent access network platform. The objective, however, has yet to be achieved, when measured in terms of the extent to which the technologies have been deployed, and as a percentage of the embedded plant.

Technology has enabled cable companies to compete for consumers, offering voice, video and data through the same facilities, pressuring LECs to compete and match the offer. There are two options often considered for adding video to the service bundle typically explored by LECs: a satellite-based video service, and/or video over DSL, specifically using either VDSL or even ADSL. Despite both being technologically viable, the service needs to be cost competitive to cable and this remains a challenge.

The cost-effectiveness of any local access network is driven by the subscriber density and the market penetration of services—the market share of households for a LEC offering local telephony has been typically >90%, while cable penetration has on average been 60-70% and for a single wireless operator in a competitive market 25-30% market share of POPs has been common.

### SUMMARY OF THE INVENTION

Embodiments of the present invention provide a hybrid communication system that includes an analog fiber optic distribution system from a central office to a remote location associated with customer premises. A central office node located at the central office is configured to transmit at least two of digital subscriber loop (DSL), cable television and/or wireless networking signals on the analog fiber optic distribution system and convert received transmissions from the analog fiber optic distribution system to the at least two of DSL, cable television and/or wireless networking signals. A remote node located at the remote location is configured to transmit at least two of wireless networking signals received from a wireless networking distribution antenna, cable television signals received from a cable television distribution system and/or DSL signals received from a copper distribution system to customer premises over the analog fiber optic distribution system and convert received transmissions from the analog fiber optic distribution system to the at least two of wireless networking signals, cable television signals and/or DSL signals.

Further embodiments of the present invention provide hybrid communication systems that include an analog fiber optic distribution system from a central office to a remote location associated with customer premises. A central office node located at the central office is configured to transmit digital subscriber loop (DSL) and cable television signals on the analog fiber optic distribution system and convert received transmissions from the analog fiber optic distribution system to DSL signals. A remote node located at the remote location is configured to convert received transmissions from the analog fiber optic distribution system to respective DSL signals for transmission over a copper distribution system to customer premises and to cable television signals for transmission over a coaxial cable distribution system to customer premises and is further configured to transmit DSL loop signals received from the copper distribution system over the analog fiber optic distribution system.

In further embodiments of the present invention, the central office node is further configured to convert received transmissions from the analog fiber optic distribution system to cable television signals. In such embodiments, the remote node is further configured to transmit cable television signals from the cable television distribution system over the analog fiber optic distribution system.

In particular embodiments of the present invention, the central office node and/or the remote node includes a plurality of frequency up converter circuits configured to convert respective DSL and cable television signals to a corresponding one of the carrier frequencies associated with the analog fiber optic distribution system. A combiner circuit is configured to receive the up converted DSL and cable television signals and combine the received up converted signals to provide an analog fiber optic signal corresponding to the received up converted signals. A fiber optic transmitter circuit is operably associated with the combiner circuit for transmitting the analog fiber optic signal on the analog fiber optic distribution system. A fiber optic receiver circuit is configured to receive an analog fiber optic signal from the analog fiber optic distribution system. A plurality of frequency down converter circuits are configured to convert the received analog fiber optic signal to respective DSL and cable television signals based on corresponding carrier frequencies associated with the analog fiber optic distribution system.

In further embodiments of the present invention, the central office node and/or the remote node further includes a plurality of hybrid circuits configured to provide DSL signals received from a copper-based infrastructure to corresponding ones of the frequency up converter circuits and receive DSL signals from corresponding ones of the frequency down converter circuits and provide the DSL signals received from the frequency down converter circuits to the copper-based infrastructure. A plurality of coaxial splitter/combiner circuits are configured to provide cable television signals received from a cable television coaxial cable infrastructure to corresponding ones of the frequency up converter circuits and receive cable television signals from corresponding ones of the frequency down converter circuits and provide the cable television signals received from the frequency down converter circuits to the cable television coaxial cable infrastructure. Additionally, the central office node and/or the remote node may include a splitter configured to receive the analog fiber optic signal from the fiber optic receiver circuit and to provide the received analog fiber optic signal to the plurality of frequency down converter circuits.

In still further embodiments of the present invention, the central office node is further configured to transmit wireless networking signals on the analog fiber optic distribution system and convert received transmissions from the analog fiber optic distribution system to wireless networking signals, such as frequency division duplex (FDD) signals including, for example, GSM, CDMA and/or WCDMA signals. The remote node is further configured to transmit wireless networking signals received from a wireless networking distribution antenna over the analog fiber optic distribution system and convert received transmissions from the analog fiber optic distribution system to wireless networking signals for transmission by the wireless networking distribution antenna.

Additional embodiments of the present invention provide a hybrid communication system that includes an analog fiber optic distribution system from a central office to a remote location associated with customer premises. A central office node located at the central office is configured to transmit wireless networking signals, for example, for a BTS or Node B, on the analog fiber optic distribution system and convert received transmissions from the analog fiber optic distribution system to wireless networking signals. A remote node located at the remote location is configured to transmit wireless networking signals received from a wireless networking distribution antenna, such as from a Remote Antenna Unit (RAU), over the analog fiber optic distribution system and convert received transmissions from the analog fiber optic distribution system to wireless networking signals for transmission by the wireless networking distribution antenna.

In further embodiments of the present invention, the central office node and/or remote node includes a plurality of frequency up converter circuits configured to convert respective wireless networking signals to a corresponding one of a carrier frequencies associated with the analog fiber optic distribution system. A combiner circuit is configured to receive the up converted wireless networking signals and combine the received up converted signals to provide an analog fiber optic signal corresponding to the received up converted signals. A fiber optic transmitter circuit operably associated with the combiner circuit is configured to transmit the analog fiber optic signal on the analog fiber optic distribution system. A fiber optic receiver circuit is configured to receive an analog fiber optic signal from the analog fiber optic distribution system. A plurality of frequency down converter circuits are configured to convert the received analog fiber optic signal to respective wireless networking signals based on corresponding carrier frequencies associated with the analog fiber optic distribution system.

In yet other embodiments of the present invention, the central office node and/or remote node further includes a plurality of wireless networking termination circuits configured to provide wireless networking signals received from a wireless networking infrastructure to corresponding ones of the frequency up converter circuits and receive wireless networking signals from corresponding ones of the frequency down converter circuits and provide the wireless networking signals received from the frequency down converter circuits to the wireless networking infrastructure. The central office node and/or remote node may further include a splitter configured to receive the analog fiber optic signal from the fiber optic receiver circuit and to provide the received analog fiber optic signal to the plurality of frequency down converter circuits.

The central office node may also be configured to transmit DSL on the analog fiber optic distribution system and convert received transmissions from the analog fiber optic distribution system to DSL signals and the remote node may be configured to convert received transmissions from the analog fiber optic distribution system to respective DSL signals for transmission over a copper distribution system to customer premises and is further configured to transmit DSL loop signals received from the copper distribution system over the analog fiber optic distribution system. Additionally or alternatively, the central office node may be further configured to transmit cable television signals on the analog fiber optic distribution system and the remote node further configured to convert received transmissions from the analog fiber optic distribution system to cable television signals for transmission over a coaxial cable distribution system to customer premises. The central office node could also be further configured to convert received transmission from the analog fiber optic distribution system of cable television signals and the remote node further configured to transmit cable television signals from the cable television distribution system over the analog fiber optic distribution system.

Further embodiments of the present invention provide for communicating cable television and digital subscriber loop signals between a central office and a remote location associated with customer premises by mutliplexing cable television signals and digital subscriber loop signals on an analog fiber optic distribution system between the central office and the remote location and demultiplexing cable television signals and digital subscriber loop signals from the analog fiber optic distribution system between the central office and the remote location. Multiplexing digital subscriber loop signals may also include filtering digital subscriber loop signals to fit within a bandwidth allocation of a channel of the analog fiber optic distribution system. Additionally, wireless networking signals may be multiplexed on the analog fiber optic distribution system between the central office and the remote location the wireless networking signals may be demultiplexed from the analog fiber optic distribution system between the central office and the remote location.

As will further be appreciated by those of skill in the art, while described above primarily with reference to system aspects, the present invention may be embodied as methods, apparatus/systems and/or computer program products.

### BRIEF DESCRIPTION OF THE DRAWINGS

FIG. 1 is a block diagram of a conventional LEC network access system;

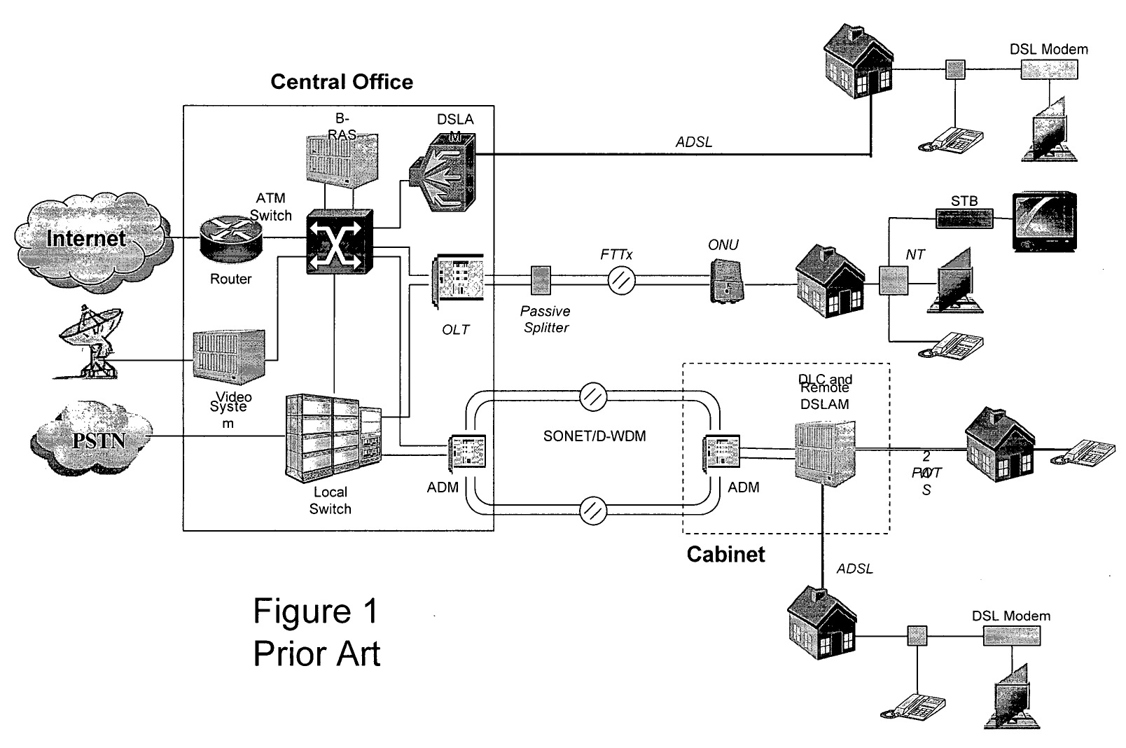

FIG. 2 is a block diagram of a conventional HFC system;

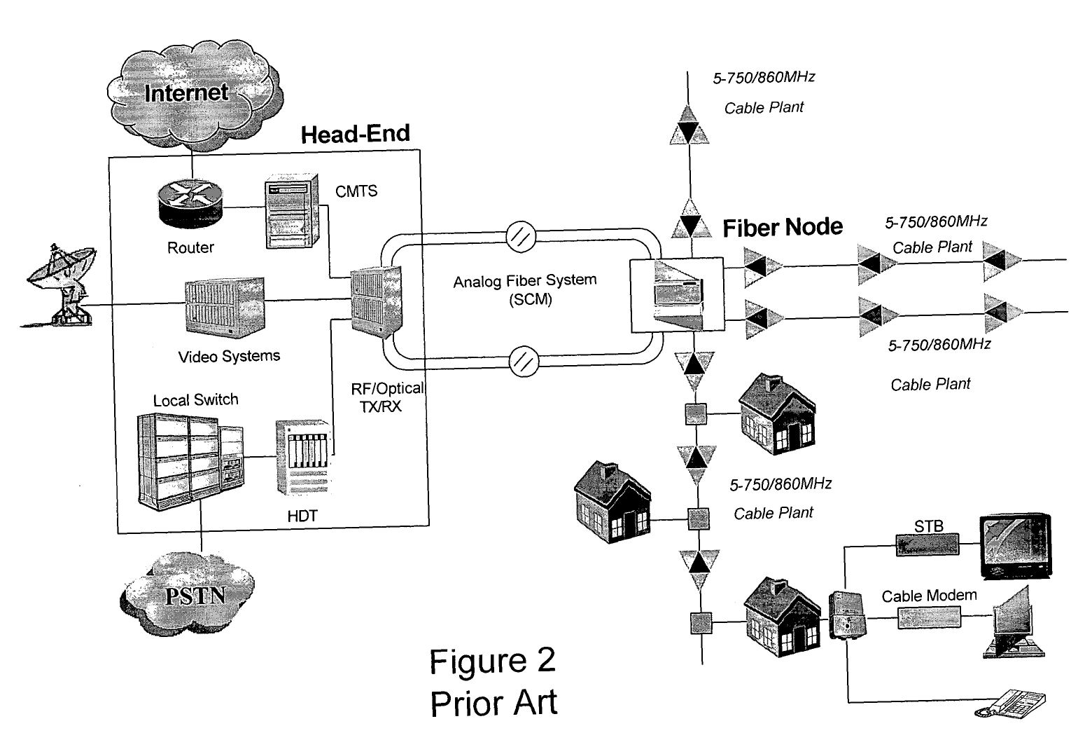

FIG. 3 is a block diagram of a conventional wireless access network system;

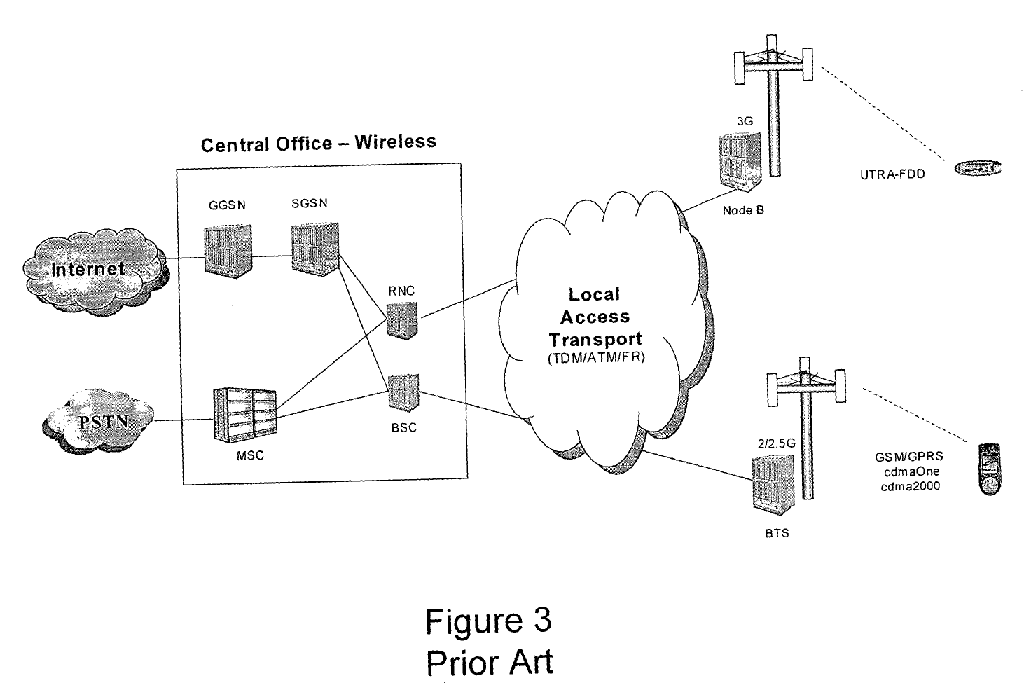

FIG. 4 is a block diagram of a hybrid network access system according to certain embodiments of the present invention;

FIG. 5 is a block diagram of a central office node according to embodiments of the present invention;

FIG. 6 is a block diagram of a remote location node according to embodiments of the present invention;

FIG. 7 is a schematic diagram illustrating multiplexing of differing media on an analog fiber optic distribution media according to embodiments of the present invention;

FIG. 8 is a block diagram illustrating a hybrid network access system incorporating wireless network access according to further embodiments of the present invention;

FIG. 9 is a block diagram of a central office node providing wireless network access according to embodiments of the present invention; and

FIG. 10 is a block diagram of a remote location node providing wireless network access according to embodiments of the present invention.

### DETAILED DESCRIPTION OF THE INVENTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As used herein, the terms digital subscriber loop of DSL is used in a generic sense to refer to any form of DSL, such as ADSL, SHDSL, VDSL or the like. Thus, the terms xDSL and DSL are used interchangeably herein. Furthermore, embodiments of the present invention are described herein with reference to cable television signals. The term cable television signals is used herein in a generic sense to refer to cable television video and/or data signals, including, for example, cable television programming signals, DOCSIS signals or the like. Embodiments of the present invention are also described with reference to wireless network signals. The term wireless networking signals is used herein in a generic sense to refer to any frequency division duplex (FDD) wireless signal, including, for example, GSM, CDMA and/or WCDMA signals.

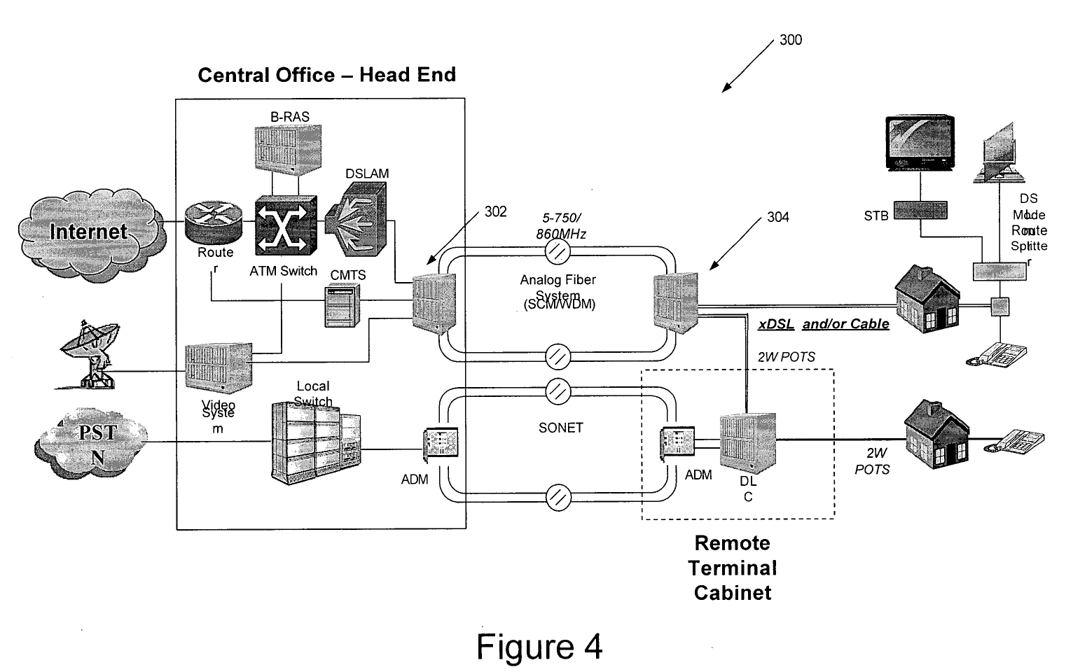

Referring now to FIG. 4, a hybrid access network 300 incorporating embodiments of the present invention is illustrated. As illustrated in FIG. 4, a central office/head end is connected to a remote location, such as in or near a remote terminal cabinet, through an analog fiber optic system. In particular embodiments of the present invention, the analog fiber optic system is an SCM/WDM fiber optic network.

At the central office, a central office node 302 provides access to the analog fiber optic system for both cable television and for DSL. The central office node 302 receives cable television signals and DSL signals and converts them for transmission onto the analog fiber optic system. In particular, the central office node 302 may multiplex the cable television signals and the DSL signals onto the analog fiber optic system. The central office node 302 also receives signals from the fiber optic system, demultiplexes them and converts them to corresponding cable television signals or DSL signals.

In particular embodiments of the present invention, an ATM switch and router may provide access to the Internet for both the DSL and the cable television/data systems. The cable television system may include both video signals from a video system, such as satellite broadcast television, and for data access through a Cable Modem Termination System (CMTS) utilizing, for example, the Data Over Cable Service Interface Specification (DOCSIS). As illustrated in FIG. 4, the CMTS may be connected to the Internet through the router rather than through the ATM switch. Thus, the cable television signals provided to and received from the central office node 302 may be video and/or data.

The DSL signals may be provided to and received from the central office node 302 by a conventional DSLAM residing at the central office. The DSLAM may provide access to the Internet through the ATM switch and/or IP router. Furthermore, access to a broadband remote access server (B-RAS) may also be provided through the ATM switch.

As is further illustrated in FIG. 4, a remote location node 304 is also connected to the analog fiber optic system. The remote location node 304 receives signals from the fiber optic system, demultiplexes them and converts them to corresponding cable television signals or DSL signals for transmission on the respective coaxial and 2W POTS distribution systems. The remote node 304 also receives cable television signals and DSL signals and converts them for transmission onto the analog fiber optic system. In particular, the remote location node 304 may multiplex the cable television signals from a coaxial distribution system to customer premises and the DSL signals from a two wire POTS (2W POTS) distribution system to customer premises onto the analog fiber optic system.

The coaxial cable distribution system and/or the 2W POTS distribution system (i.e. a copper-based distribution system) may run to a customer premises. At the customer premises conventional systems for use of DSL and/or cable television signals may be provided. Thus, for example, a DSL modem, router and splitter may be used to provide DSL network access to a workstation. Similarly, a conventional set top box (STB) may receive video signals from the coaxial distribution system and provide the video signals to a television. A cable modem could also provide high speed network access to a workstation over the coaxial cable distribution system. Additionally, a 2W POTS connection may be provided from the remote location node 304 to a conventional DLC at a remote terminal cabinet. The DLC may then provide a 2W POTS connection to customer premises.

In addition to a hybrid system according to embodiments of the present invention, FIG. 4 also illustrates a conventional SONET/SDH distribution system. For example, a local switch at the central office provides access to the public switched telephone network (PSTN) and may be connected to an ADM that interfaces with a SONET/SDH fiber optic distribution system. A second ADM at the remote terminal cabinet provides an interface to the SONET/SDH fiber optic distribution system for the DLC that provides 2W POTS connections to customer premises as described above. Thus, embodiments of the present invention may be incorporated with conventional telephony distribution systems to provide further capabilities to customers.

While a particular hybrid system is illustrated in FIG. 4, embodiments of the present invention should not be construed as limited to a particular system configuration but is intended to encompass any system that provides DSL and cable television signals over an analog fiber optic system. Thus, for example, the configuration of the equipment at the central office/head end may differ from system to system as may the interconnection between components at the central office/head end. Similarly, different connections to customer premises and/or different configurations of equipment at customer premises may be provided while still benefiting from the teachings of the present invention. Also, while embodiments of the present invention are illustrated in FIG. 4 as being separate nodes, the analog fiber access for cable television and DSL signals provided by the nodes 302 and 304 could be incorporated into other equipment, such as the DSLAM, CMTS or DLC. Accordingly, the present invention should not be construed as limited to the particular division of functions illustrated in FIG. 4.

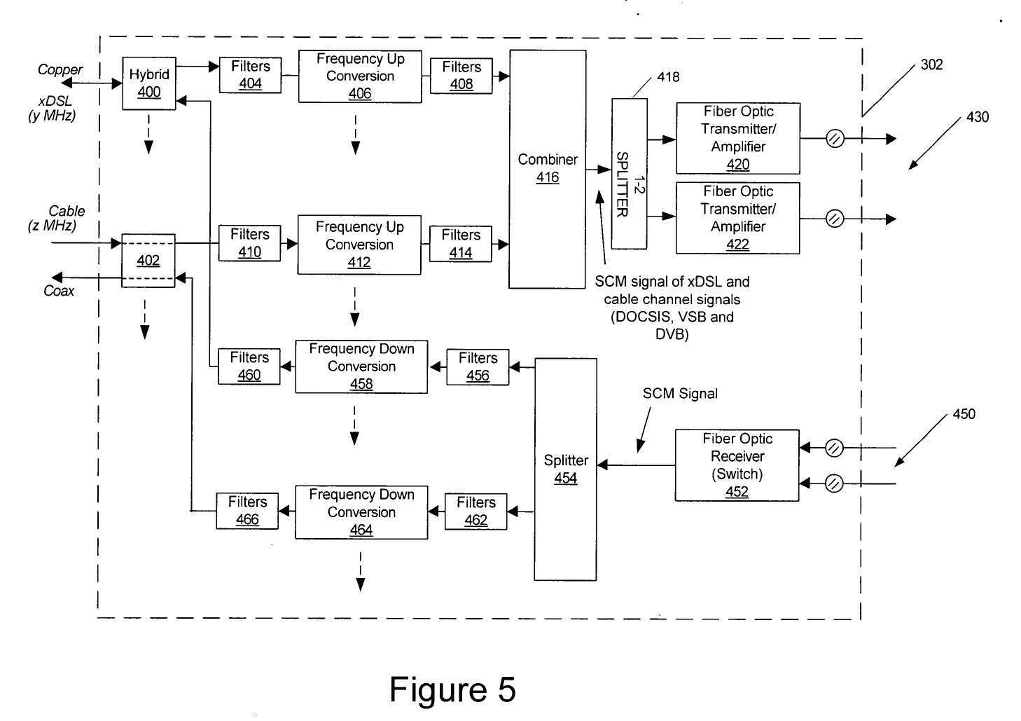

FIG. 5 is a block diagram of an exemplary central office node 302 according to some embodiments of the present invention. As seen in FIG. 5, the central office node 302 receives and transmits xDSL signals, having a bandwidth of y MHz, on a copper-based connection. For example, the central office node 302 may receive DSL signals from and transmit DSL signals to a DSLAM or even a single DSL modem. The central office node 302 also receives and transmits cable television signals, having a bandwidth of z MHz, on a coaxial based connection. For example, the central office node 302 may receive cable television signals from and transmit cable television signals to a CMTS, a video system or other such cable television equipment.

The central office node 302 also transmits analog fiber optic signals 430 and receives analog fiber optic signals 450 from an analog fiber optic distribution system. In particular, the central office node 302 illustrated in FIG. 5 transmits and receives subcarrier modulated signals. However, other systems for multiplexing analog signals onto the fiber optic distribution system, such as wavelength division modulated signals, may also be utilized.

Turning to the specifics of FIG. 5, xDSL signals are transmitted from and received by a hybrid circuit 400. The hybrid circuit 400 may be a conventional hybrid circuit such as those used in conventional DSL communications for combining and separating transmitted and received DSL signals. The arrows in FIG. 5 illustrate that multiple copies of the illustrated component or components may be provided. Thus, for example, multiple hybrid circuits 400 may be provided in the central office node 302 illustrated in FIG. 5.

The hybrid circuit 400 provides received DSL signals to one of a plurality of frequency conversion circuits. The frequency conversion circuits illustrated in FIG. 5 for converting DSL signals include filters 404, a frequency up conversion circuit 406 and filters 408. The filters 404 and 406 may remove unwanted frequencies from the DSL signals before and after conversion to a carrier frequency of the analog fiber optic distribution system by the frequency up conversion circuit 406. The particular pass frequencies of the filters 404 and 408 may depend on the particular DSL signals being converted and/or the carrier frequency of the analog fiber optic distribution system. The frequency up conversion circuit 406 converts the DSL signals to provide frequency modulated signals about a carrier frequency associated with a channel of the fiber optic distribution system so as to up-convert the DSL signal to the fiber optic carrier frequency. Techniques for such filtering and frequency conversions are known to those of skill in the art and, therefore, will not be described further herein.

Cable television signals are transmitted from and received by a coaxial termination circuit 402. The coaxial termination circuit 402 may be a convention coaxial termination circuit such as those used in conventional cable television communications. Multiple coaxial termination circuits 402 may be provided in the central office node 302 illustrated in FIG. 5. In particular embodiments of the present invention, the coaxial termination circuits 402 may be diplexers.

The cable television termination circuit 402 also provides received cable television signals to one of a plurality of frequency conversions circuits. The frequency conversion circuits illustrated in FIG. 5 for converting cable television signals include filters 410, a frequency up conversion circuit 412 and filters 414. The filters 410 and 414 may remove unwanted frequencies from the cable television signals before and after conversion to a carrier frequency of the analog fiber optic distribution system by the frequency up conversion circuit 412. The particular pass frequencies of the filters 410 and 414 may depend on the particular cable television signals being converted and/or the carrier frequency of the analog fiber optic distribution system. The frequency up conversion circuit 412 converts the cable television signals to provide frequency modulated signals about a carrier frequency associated with a channel of the fiber optic distribution system so as to Lip-convert the cable television signal to the fiber optic carrier frequency. Techniques for such filtering and frequency conversions are known to those of skill in the art and, therefore, will not be described further herein.

The frequency converted DSL signals and cable television signals are provided to a combiner 416 that combines the signals into a single signal that provides an SCM signal of the DSL and cable television signals. For example, the output of the combiner 416 may include xDSL, DOCSIS, analog video, vestigial sideband (VSB) and/or digital video broadcast (DVB) signals. The output of the combiner 416 is provided to a 1 to 2 splitter 418 to provide two SCM signals for transmission on the fiber optic distribution system by the fiber optic transmitter/amplifiers 420 and 422.

As is further illustrated in FIG. 5, signals 450 from the analog fiber optic distribution system are received by the fiber optic receiver (switch) 452 and an SCM signal is provided to a splitter 454. The splitter 454 provides copies of the SCM signal to ones of a plurality of frequency conversion circuits that convert the received signal to corresponding DSL or cable television signals to be provided to respective ones of the hybrid circuits 400 or cable television termination circuits 402.

The frequency conversion circuits illustrated in FIG. 5 for converting SCM signals to corresponding DSL signals include filters 456, a frequency down conversion circuit 458 and filters 460. The filters 456 and 460 may remove unwanted frequencies from the SCM signals before and after conversion from a carrier frequency of the analog fiber optic distribution system by the frequency down conversion circuit 458. The particular pass frequencies of the filters 456 and 458 may depend on the particular DSL signals being converted and/or the carrier frequency of the analog fiber optic distribution system. The frequency down conversion circuit 458 converts the SCM signal for a carrier frequency associated with a channel of the fiber optic distribution system to extract a DSL signal so as to down-convert the DSL signal from the fiber optic carrier frequency. Techniques for such filtering- and frequency conversions are known to those of skill in the art and, therefore, will not be described further herein.

The frequency conversion circuits illustrated in FIG. 5 for converting SCM signals to cable television signals include filters 462, a frequency down conversion circuit 464 and filters 466. The filters 462 and 466 may remove unwanted frequencies from the SCM signals before and after conversion from a carrier frequency of the analog fiber optic distribution system by the frequency down conversion circuit 464. The particular pass frequencies of the filters 462 and 466 may depend on the particular cable television signals being converted and/or the carrier frequency of the analog fiber optic distribution system. The frequency down conversion circuit 464 converts the SCM signal for a carrier frequency associated with a channel of the fiber optic distribution system to extract a cable television signal so as to down-convert the cable television signal from the fiber optic carrier frequency. Techniques for such filtering and frequency conversions are known to those of skill in the art and, therefore, will not be described further herein.

The DSL signals and cable television signals extracted from the SCM signal by the frequency conversion circuits are provided to corresponding ones of the hybrids 400 and the cable television termination circuits 402. Thus, the SCM signals are converted from analog fiber optic distribution system signals to corresponding cable television signals and DSL signals by the central office node 302.

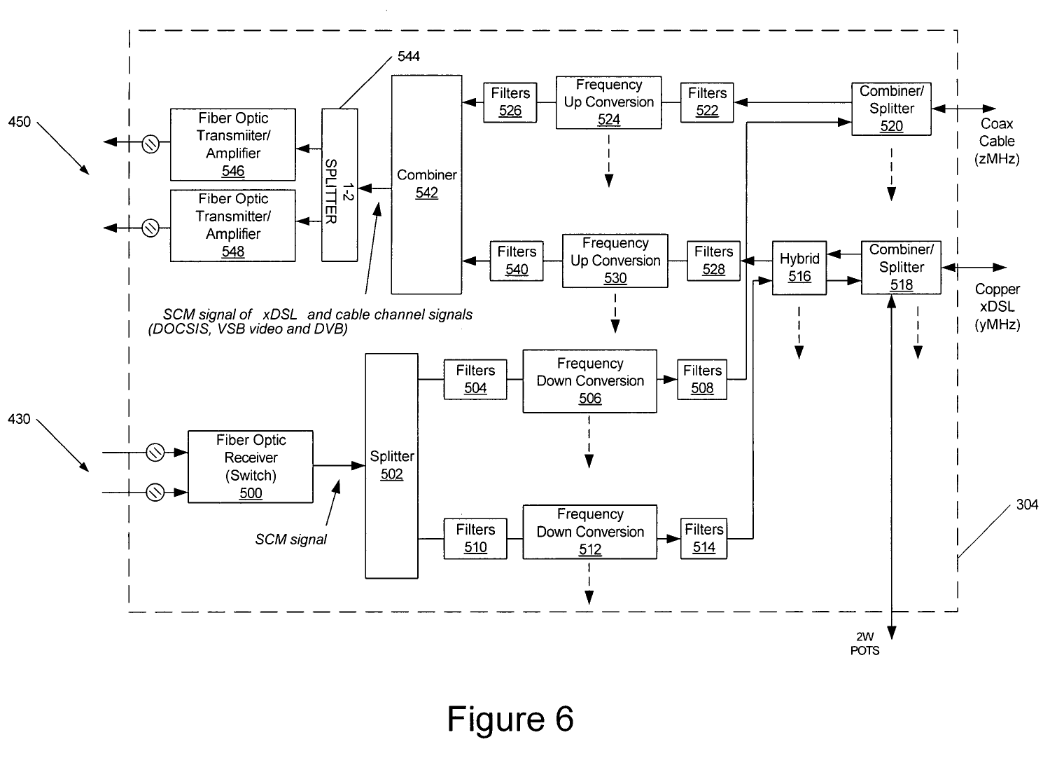

FIG. 6 is a block diagram of an exemplary remote location node 304 according to some embodiments of the present invention. As seen in FIG. 6, the remote location node 304 receives and transmits xDSL signals, having a bandwidth of y MHz, on a copper-based connection. For example, the remote location node 304 may receive DSL signals from and transmit DSL signals to DSL modems at customer premises and/or provide 2W POTS signals to a DLC at a remote terminal cabinet as illustrated in FIG. 4. The remote location node 304 also receives and transmits cable television signals, having a bandwidth of z MHz, on a coaxial based connection. For example, the remote location node 304 may receive cable television signals from and transmit cable television signals to customer premises and/or repeater amplifiers of a coaxial cable television distribution system.

The remote location node 304 also receives analog fiber optic signals 430 and transmits analog fiber optic signals 450 from an analog fiber optic distribution system. In particular, the remote location node 304 illustrated in FIG. 6 transmits and receives subcarrier modulated signals. However, other systems for multiplexing analog signals onto the fiber optic distribution system, such as wavelength division modulated signals, may also be utilized.

Turning to the specifics of FIG. 6, xDSL signals are transmitted from and received by a combiner/splitter circuits 518 that provides DSL signals to and receives DSL signals from hybrid circuits 516. The hybrid circuits 516 maybe a conventional hybrid circuit such as those used in conventional DSL communications for combining and separating transmitted and received DSL signals. The arrows in FIG. 6 illustrate that multiple copies of the illustrated component or components may be provided. Thus, for example, multiple hybrid circuits 516 may be provided in the remote location node 304 illustrated in FIG. 6.

The hybrid circuit 516 provides received DSL signals to one of a plurality of frequency conversions circuits. The frequency conversion circuits illustrated in FIG. 6 for converting DSL signals include filters 528, a frequency up conversion circuit 530 and filters 540. The filters 528 and 540 may remove unwanted frequencies from the DSL signals before and after conversion to a carrier frequency of the analog fiber optic distribution system by the frequency up conversion circuit 530. The particular pass frequencies of the filters 528 and 540 may depend on the particular DSL signals being converted and/or the carrier frequency of the analog fiber optic distribution system. The frequency up conversion circuit 530 converts the DSL signals to provide frequency modulated signals about a carrier frequency associated with a channel of the fiber optic distribution system so as to up-convert the DSL signal to the fiber optic carrier frequency. Techniques for such filtering and frequency conversions are known to those of skill in the art and, therefore, will not be described further herein.

Cable television signals are transmitted from and received by a combiner/splitter circuit 520. The combiner/splitter circuit 520 may be a conventional combiner/splitter circuit such as those used in conventional cable television communications. Multiple combiner/splitter circuits 520 may be provided in the remote location node 304 illustrated in FIG. 6. In particular embodiments of the present invention, the combiner/splitter circuits 520 may be diplexers.

The combiner/splitter circuit 520 also provides received cable television signals to one, of a plurality of frequency conversions circuits. The frequency conversion circuits illustrated in FIG. 6 for converting cable television signals include filters 522, a frequency up conversion circuit 524 and filters 526. The filters 522 and 526 may remove unwanted frequencies from the cable television signals before and after conversion to a carrier frequency of the analog fiber optic distribution system by the frequency up conversion circuit 524. The particular pass frequencies of the filters 522 and 526 may depend on the particular cable television signals being converted and/or the carrier frequency of the analog fiber optic distribution system. The frequency up conversion circuit 524 converts the cable television signals to provide frequency modulated signals about a carrier frequency associated with a channel of the fiber optic distribution system so as to up-convert the cable television signal to the fiber optic carrier frequency. Techniques for such filtering and frequency conversions are known to those of skill in the art and, therefore, will not be described further herein.

The frequency converted DSL signals and cable television signals are provided to a combiner 542 that combines the signals into a single signal that provides an SCM signal of the DSL and cable television signals. For example, the output of the combiner 542 may include xDSL, DOCSIS, analog video, vestigial sideband (VSB) and/or digital video broadcast (DVB) signals. The output of the combiner 542 is provided to a 1 to 2 splitter 544 to provide two SCM signals for transmission on the fiber optic distribution system by the fiber optic transmitter/amplifiers 546 and 548.

As is further illustrated in FIG. 6, signals 430 from the analog fiber optic distribution system are received by the fiber optic receiver (switch) 500 and an SCM signal is provided to a splitter 502. The splitter 502 provides copies of the SCM signal to one of a plurality of frequency conversion circuits that convert the received signal to corresponding DSL or cable television signals to be provided to respective ones of the hybrid circuits 516 or the combiner/splitter circuits 520.

The frequency conversion circuits illustrated in FIG. 6 for converting SCM signals to corresponding DSL signals include filters 510, a frequency down conversion circuit 512 and filters 514. The filters 510 and 514 may remove unwanted frequencies from the SCM signals before and after conversion from a carrier frequency of the analog fiber optic distribution system by the frequency down conversion circuit 512. The particular pass frequencies of the filters 510 and 514 may depend on the particular DSL signals being converted and/or the carrier frequency of the analog fiber optic distribution system. The frequency down conversion circuit 512 converts the SCM signal for a carrier frequency associated a channel of the fiber optic distribution system to extract a DSL signal so as to down-convert the DSL signal from the fiber optic carrier frequency. Techniques for such filtering and frequency conversions are known to those of skill in the art and, therefore, will not be described further herein.

The frequency conversion circuits illustrated in FIG. 6 for converting SCM signals to cable television signals include filters 504, a frequency down conversion circuit 506 and filters 508. The filters 504 and 508 may remove unwanted frequencies from the SCM signals before and after conversion from a carrier frequency of the analog fiber optic distribution system by the frequency down conversion circuit 506. The particular pass frequencies of the filters 504 and 508 may depend on the particular cable television signals being converted and/or the carrier frequency of the analog fiber optic distribution system. The frequency down conversion circuit 506 converts the SCM signal for a carrier frequency associated with a channel of the fiber optic distribution system to extract a cable television signal so as to down-convert the cable television signal from the fiber optic carrier frequency. Techniques for such filtering and frequency conversions are known to those of skill in the art and, therefore, will not be described further herein.

The DSL signals and cable television signals extracted from the SCM signal by the frequency conversion circuits are provided to corresponding ones of the hybrids 516 and the cable television termination circuits 520. Thus, the SCM signals are converted from analog fiber optic distribution system signals to corresponding cable television signals and DSL signals by the remote location node 304.

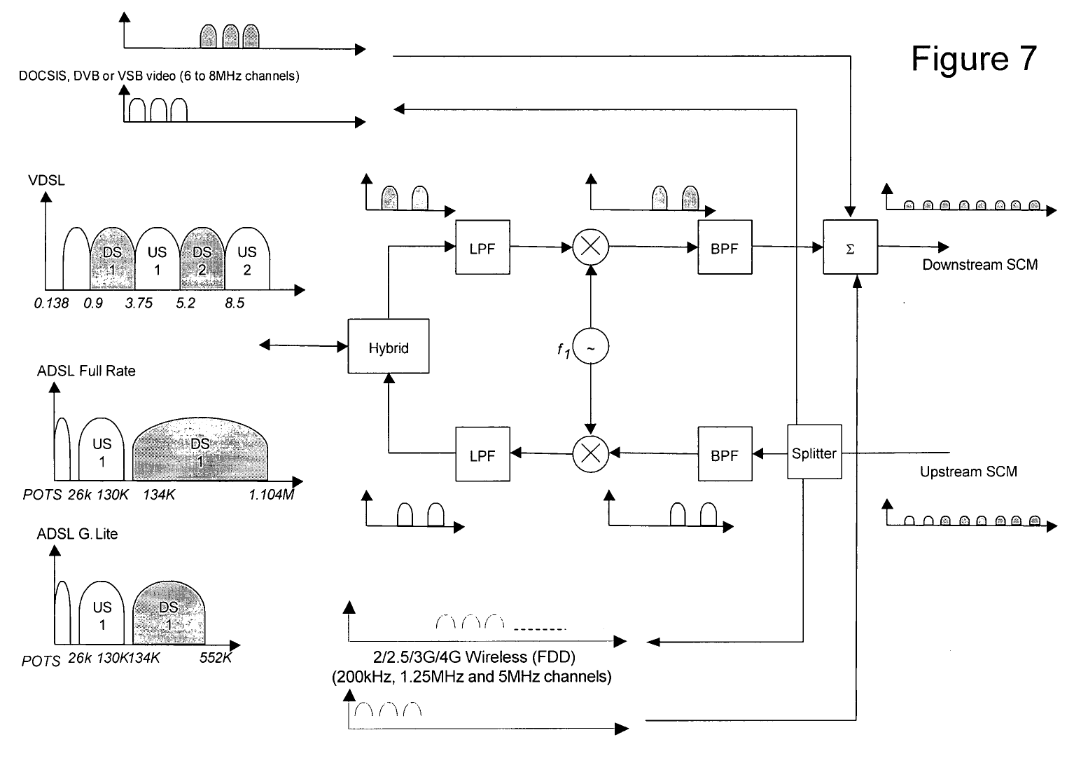

FIG. 7 illustrates multiplexing of cable television, wireless networking and various DSL signals onto an analog fiber optic distribution system according to some embodiments of the present invention. As seen in FIG. 7, an SCM analog fiber optic distribution system may provide a plurality of upstream and downstream carriers on the fiber optic system. For example, 6 to 8 MHz wide channels may be provided on a fiber optic system as provided, for example, in cable television service. In particular, in conventional cable television fiber optic systems in the U.S., 6 MHz channels are provided while in Europe 8 MHz channels are provided. Various types of DSL may be readily converted to the 6 to 8 MHz channels as the frequency bandwidth requirements of the DSL signals are less than 6 to 8 MHz. For example, ADSL full rate may utilize up to about 1.104 MHz for downstream and 130 kHz for upstream communications and POTS signals. Similarly, frequencies of up to about 552 KHz may be used for “ADSL Lite” downstream and 130 kHz for upstream communications. Thus, a number of full rate and lite ADSL may be directly translated an multiplexed into the 6 to 8 MHz channels of conventional fiber optic systems utilized in cable television distribution.

However, for VDSL, the upstream and downstream communications may take more than 6 MHz or even more than 8 MHz as seen in FIG. 7. Thus, the VDSL signal may be filtered to remove the upstream 2 and/or downstream 2 frequencies so as to fit within the 8 MHz channels.

An example of the generation of the SCM signals from DSL signals is illustrated in FIG. 7. As seen in FIG. 7, the downstream DSL signals are provided to a hybrid that provides downstream signals to a low pass filter that may filter out frequencies above the channel frequency bandwidth (e.g., 6 or 8 MHz). The filtered downstream signals are then upconverted to by the frequency f₁ to the carrier frequency of a channel of the downstream SCM and bandpass filtered to the corresponding frequency band of the channel. As is further illustrated in FIG. 7, the cable television signals, including data, may already be provided as 6 to 8 MHz channels according to the DOCSIS requirements and may be directly summed with the converted DSL signals and provided to the fiber optic distribution system for transmission on the downstream SCM system.

Furthermore, the upstream cable television (e.g. data) signals may be directly extracted from the upstream SCM signal utilizing a splitter to separate the cable television signals from the DSL signals. The DSL signals may be bandpass filtered to isolate the corresponding channel of the upstream SCM signal and frequency down converted from the carrier frequency of the channel f₁. The down converted signal may then be low pass filtered at the maximum frequency of the corresponding DSL signal or at the maximum channel frequency bandwidth (e.g. 6 or 8 MHz) and the resulting signal provided to the hybrid to provide the DSL signal.

As is further illustrated in FIG. 7, 2G, 2.5G, 3G and/or 4G FDD wireless networking signals also may be multiplexed on the fiber optic distribution system. These FDD wireless networking signals may be converted to the SCM channels as the bandwidth channels of the FDD systems are 200 kHz, 1,25 MHz or 5 MHz which are less than the 6 or 8 MHz bandwidth provided by the SCM system.

As will be appreciated by those of skill in the art, these operations may be reversed at the remote end of the SCM distribution system so as to convert the downstream SCM signals to DSL, wireless networking and/or cable television signals and to convert DSL, wireless networking and/or cable television signals to upstream SCM signals.

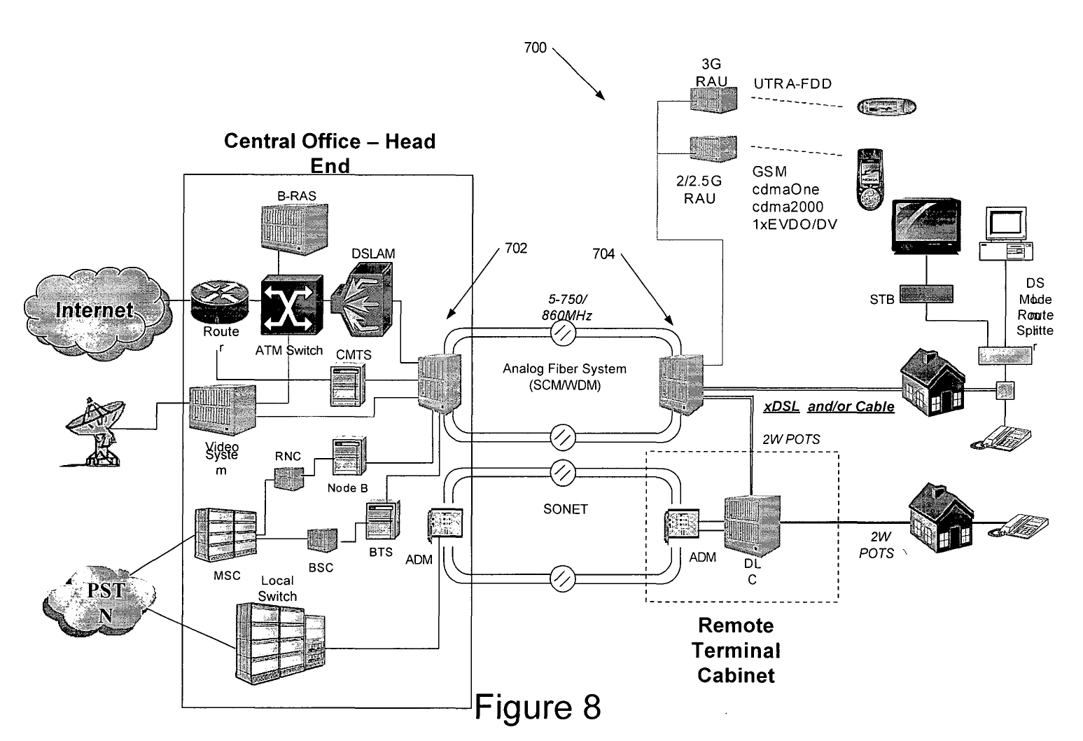

FIG. 8 illustrates further embodiments of the present invention. As illustrated in FIG. 8, in addition to the distribution of DSL and cable television signals over the analog fiber system, wireless networking signals may also be distributed over the analog fiber system. Thus, for example, a central office node 702 and a remote location node 704 may communicate over the analog fiber system and may receive and transmit wireless signals over the analog fiber system.

At the central office, a central office node 702 provides access to the analog fiber optic system for wireless networking, cable television and for DSL. The central office node 702 receives wireless networking, cable television signals and DSL signals and converts them for transmission onto the analog fiber optic system. In particular, the central office node 702 may multiplex the wireless networking, cable television signals and the DSL signals onto the analog fiber optic system. The central office node 702 also receives signals from the fiber optic system, demultiplexes them and converts them to corresponding wireless networking, cable television signals or DSL signals.

In particular embodiments of the present invention, an ATM switch and router may provide access to the Internet for the wireless networking, the DSL and the cable television systems. The cable television system and DSL systems may be as described above with reference to FIG. 4. The wireless networking may be provided, for example, by wireless equipment, such as a base station (BTS/Node B), that is connected to either a BSC or RNC and to the central office node 702. As is further illustrated in FIG. 8, a remote location node 704 is also connected to the analog fiber optic system. The remote node 704 receives wireless networking, cable television signals and DSL signals and converts them for transmission onto the analog fiber optic system. In particular, the remote location node 704 may multiplex the wireless networking signals from a transmitter/receiver amplifier of an antenna of the wireless networking system, cable television signals from a coaxial distribution system to customer premises and the DSL signals from a two wire POTS (2W POTS) distribution system to customer premises onto the analog fiber optic system. The remote location node 704 also receives signals from the fiber optic system, demultiplexes them and converts them to corresponding wireless networking signals, cable television signals or DSL signals for transmission on the respective wireless network, coaxial and 2W POTS distribution systems.

The coaxial cable distribution system and/or the 2W POTS distribution system (i.e. a copper-based distribution system) may be as discussed above with reference to FIG. 4. The wireless networking distribution system may include transmitter/receiver amplifiers and antennas that transmit and receive wireless data from customer premises and/or individual devices, such as mobile phones, workstations, personal digital assistants or the like. At the customer premises or with the individual devices, conventional systems for providing wireless network access may be provided. Wireless networking, such as frequency division duplex (FDD), including for example, GSM, CDMA, WCDMA, may be utilized in particular embodiments of the present invention.

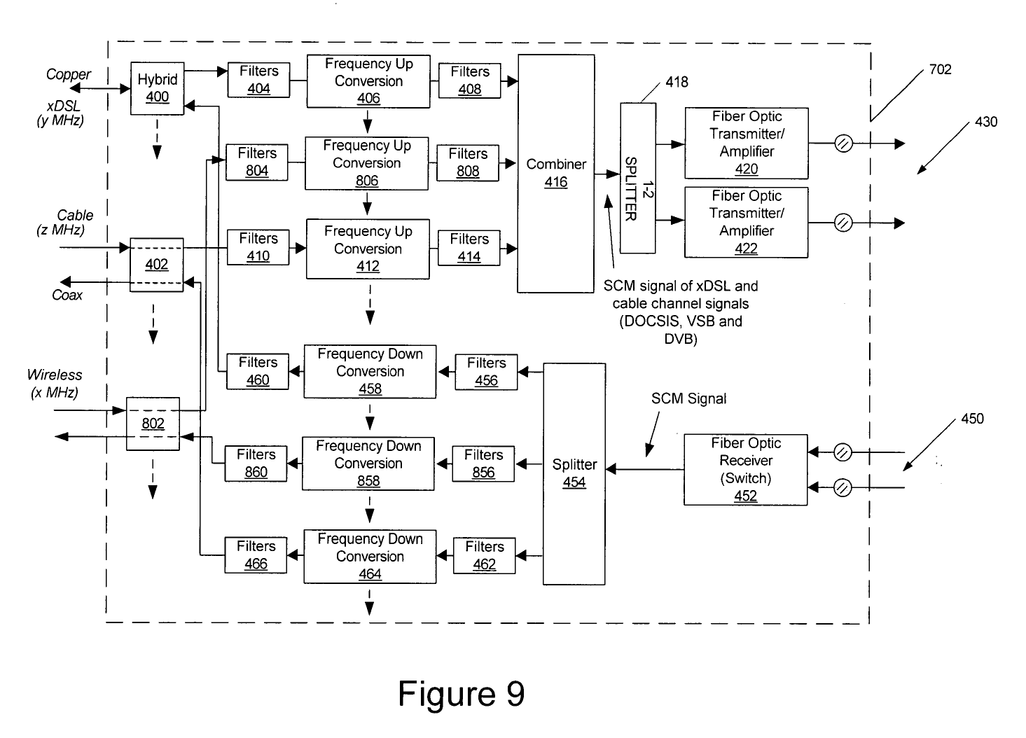

FIG. 9 is a block diagram of an exemplary central office node 702 according to some embodiments of the present invention. As seen in FIG. 9, the central office node 702 may include the same functionality as described above with reference to FIG. 5 and further receives and transmits wireless signals, having a bandwidth of x MHz, for distribution on a wireless media. For example, the central office node 702 may receive wireless networking signals from and transmit wireless networking signals to a wireless base station. The wireless networking signals may be, for example, frequency modulated signals for transmission on an antenna associated with the wireless base station.

The central office node 702 also transmits analog fiber optic signals 430 and receives analog fiber optic signals 450 from an analog fiber optic distribution system. In particular, the central office node 702 illustrated in FIG. 9 transmits and receives sub-carrier modulated signals. However, other systems for multiplexing analog signals onto the fiber optic distribution system, such as wavelength division modulated signals, may also be utilized.

Turning to the specifics of FIG. 9, in addition to the circuitry described above for xDSL and cable television signals, wireless networking signals are transmitted from and received by a wireless networking termination circuit 802. The wireless networking and termination circuit 802 may be a wireless networking termination circuit, such as a diplexer, utilized between a wireless access point and an antenna of the wireless access point and may combine and separate transmitted and received wireless networking signals. The arrows in FIG. 9 illustrate that multiple copies of the illustrated component or components may be provided. Thus, for example, multiple wireless networking termination circuits 802 may be provided in the central office node 702 illustrated in FIG. 9.

The wireless networking termination circuit 802 provides received wireless networking signals to one of a plurality of frequency conversions circuits. The frequency conversion circuits illustrated in FIG. 9 for converting DSL signals include filters 804, a frequency up conversion circuit 806 and filters 808. The filters 804 and 806 may remove unwanted frequencies from the wireless networking signals before and after conversion to a carrier frequency of the analog fiber optic distribution system by the frequency up conversion circuit 806. The particular pass frequencies of the filters 804 and 808 may depend on the particular wireless networking signals being converted and/or the carrier frequency of the analog fiber optic distribution system. The frequency up conversion circuit 806 converts the wireless networking signals to provide frequency modulated signals about a carrier frequency associated with a channel of the fiber optic distribution system so as to up-convert the wireless networking signal to the fiber optic carrier frequency. Techniques for such filtering and frequency conversions are known to those of skill in the art and, therefore, will not be described further herein.

The frequency converted wireless networking signals, DSL signals and cable television signals are provided to a combiner 416 that combines the signals into a single signal that provides an SCM signal of the wireless networking, DSL and cable television signals. For example, the output of the combiner 416 may include wireless networking, xDSL, DOCSIS, vestigial sideband (VSB) and/or digital video broadcast (DVB) signals. The output of the combiner 416 is provided to a 1 to 2 splitter 418 to provide two SCM signals for transmission on the fiber optic distribution system by the fiber optic transmitter/amplifiers 420 and 422.

As is further illustrated in FIG. 9, signals 450 from the analog fiber optic distribution system are received by the fiber optic receiver (switch) 452 and an SCM signal is provided to a splitter 454. The splitter 454 provides copies of the SCM signal to ones of a plurality of frequency conversion circuits that convert the received signal to corresponding wireless networking, DSL or cable television signals to be provided to respective ones of the hybrid circuits 400, cable television termination circuits 402 or wireless networking termination circuits 802.

The frequency conversion circuits illustrated in FIG. 9 for converting SCM signals to corresponding cable television and DSL signals may be the same as those described above with reference to FIG. 5. However, frequency conversion circuits for converting SCM signals to wireless networking signals include filters 856, a frequency down conversion circuit 858 and filters 860. The filters 856 and 860 may remove unwanted frequencies from the SCM signals before and after conversion from a carrier frequency of the analog fiber optic distribution system by the frequency down conversion circuit 858. The particular pass frequencies of the filters 856 and 858 may depend on the particular wireless networking signals being converted and/or the carrier frequency of the analog fiber optic distribution system. The frequency down conversion circuit 858 converts the SCM signal for a carrier frequency associated a channel of the fiber optic distribution system to extract a wireless networking signal so as to down-convert the wireless networking signal from the fiber optic carrier frequency. Techniques for such filtering and frequency conversions are known to those of skill in the art and, therefore, will not be described further herein.

The wireless networking signals, DSL signals and cable television signals extracted from the SCM signal by the frequency conversion circuits are provided to corresponding ones of the wireless networking termination circuits 802, the hybrids 400 and the cable television termination circuits 402. Thus, the SCM signals are converted from analog fiber optic distribution system signals to corresponding wireless networking signals, cable television signals and DSL signals by the central office node 702.

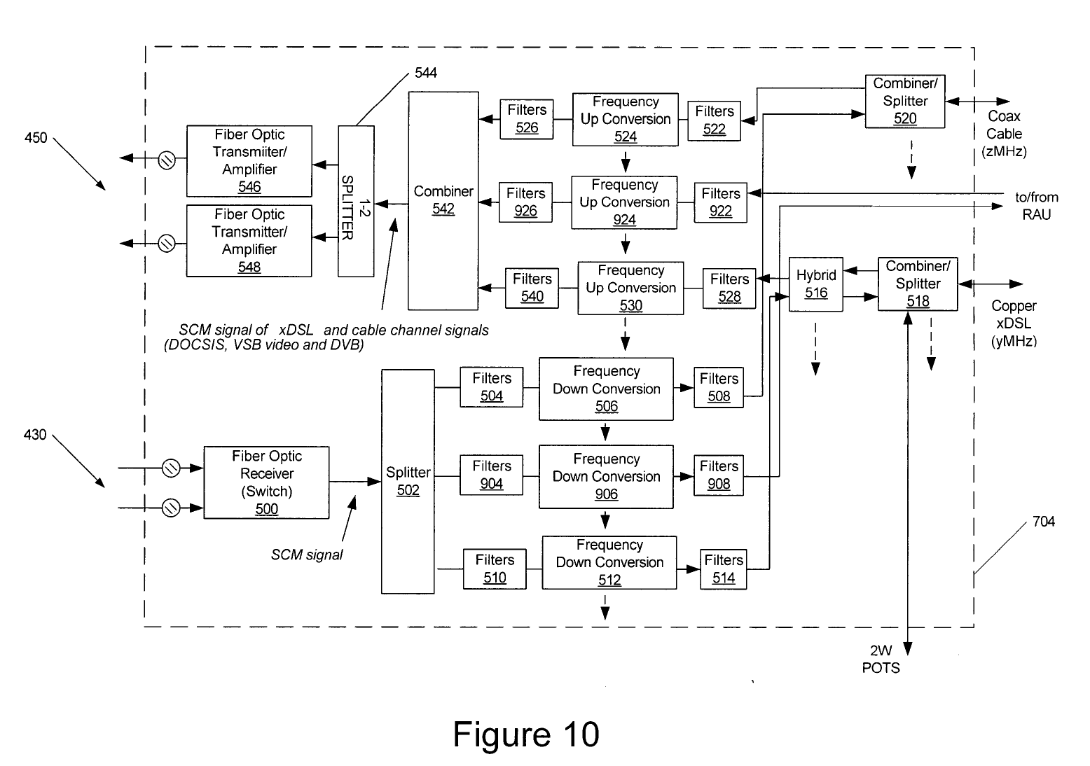

FIG. 10 is a block diagram of an exemplary remote location node 704 according to some embodiments of the present invention. As seen in FIG. 10, the central office node 702 may include the same functionality as described above with reference to FIG. 5 and further receives and transmits wireless signals, having a bandwidth of x MHz, for distribution on a wireless media. The wireless signals may be received and transmitted to amplifiers of a transmitter/receiver for transmission by an antenna associated with the transmitter/receiver amplifiers.

The remote location node 704 also receives analog fiber optic signals 430 and transmits analog fiber optic signals 450 from an analog fiber optic distribution system. In particular, the remote location node 704 illustrated in FIG. 10 transmits and receives subcarrier modulated signals. However, other systems for multiplexing analog signals onto the fiber optic distribution system, such as wavelength division modulated signals, may also be utilized.

Turning to the specifics of FIG. 10, xDSL and cable television signals may be provided for in the same manner as described above with reference to FIG. 6. Additionally, wireless networking signals are transmitted to and received from a remote antenna unit (RAU) are provided to one of a plurality of frequency conversions circuits. The frequency conversion circuits illustrated in FIG. 10 for converting wireless networking signals include filters 922, a frequency up conversion circuit 924 and filters 926. The filters 922 and 926 may remove unwanted frequencies from the wireless networking signals before and after conversion to a carrier frequency of the analog fiber optic distribution system by the frequency up conversion circuit 924. The particular pass frequencies of the filters 922 and 926 may depend on the particular wireless networking signals being converted and/or the carrier frequency of the analog fiber optic distribution system. The frequency up conversion circuit 924 converts the wireless networking signals to provide frequency modulated signals about a carrier frequency associated with a channel of the fiber optic distribution system so as to up-convert the wireless networking signal to the fiber optic carrier frequency. Techniques for such filtering and frequency conversions are known to those of skill in the art and, therefore, will not be described further herein.

The frequency converted wireless networking signals, DSL signals and cable television signals are provided to a combiner 542 that combines the signals into a single signal that provides an SCM signal of the DSL and cable television signals. For example, the output of the combiner 542 may include xDSL, DOCSIS, vestigial sideband (VSB) and/or digital video broadcast (DVB) signals. The output of the combiner 542 is provided to a 1 to 2 splitter 544 to provide two SCM signals for transmission on the fiber optic distribution system by the fiber optic transmitter/amplifiers 546 and 548.

As is further illustrated in FIG. 10, signals 430 from the analog fiber optic distribution system are received by the fiber optic receiver (switch) 500 and an SCM signal is provided to a splitter 502. The splitter 502 provides copies of the SCM signal to ones of a plurality of frequency conversion circuits that convert the received signal to corresponding wireless networking, DSL or cable television signals to be provided to respective ones of the combiner/splitter circuits 920, hybrid circuits 516 or the combiner/splitter circuits 520.

The frequency conversion circuits illustrated in FIG. 10 for converting SCM signals to corresponding cable television and DSL signals may be as described above with reference to FIG. 6. Additionally, the frequency conversion circuits illustrated in FIG. 10 for converting SCM signals to wireless networking signals include filters 904, a frequency down conversion circuit 906 and filters 908. The filters 904 and 908 may remove unwanted frequencies from the SCM signals before and after conversion from a carrier frequency of the analog fiber optic distribution system by the frequency down conversion circuit 906. The particular pass frequencies of the filters 904 and 908 may depend on the particular wireless networking signals being converted and/or the carrier frequency of the analog fiber optic distribution system. The frequency down conversion circuit 906 converts the SCM signal for a carrier frequency associated a channel of the fiber optic distribution system to extract a wireless networking signal so as to down-convert the wireless networking signal from the fiber optic carrier frequency. Techniques for such filtering and frequency conversions are known to those of skill in the art and, therefore, will not be described further herein.

The wireless networking signals, DSL signals and cable television signals extracted from the SCM signal by the frequency conversion circuits are provided to corresponding ones of the combiner/splitter circuits 920, the hybrids 516 and the cable television termination circuits 520. Thus, the SCM signals are converted from analog fiber optic distribution system signals to corresponding cable television signals and DSL signals by the remote location node 704.

While FIGS. 9 and 10 have been described with reference to a combination of wireless networking, DSL and cable television communications, in particular embodiments of the present invention wireless networking distribution over an optical fiber distribution system is provided with one of cable television communications or DSL communications. In such cases, the corresponding portions of FIGS. 9 and 10 may be removed. For example, if wireless networking is provided with DSL, the central office node 702 could be modified by removing the cable termination circuits 402, the filter circuits 410, 414, 462 and 466, the frequency up conversion circuits 412 and the frequency down conversion circuits 464. Similar modifications could be made to remote location node 704 of FIG. 10.

While FIGS. 5, 6, 9 and 10 illustrate nodes 302, 204, 702 and 704 where DSL, cable television signal and/or wireless sources have a fixed relationship to carrier frequencies of the fiber optic distribution system, in other embodiments of the present invention, variable relationships may be provided. Such a variable relationship may provide flexibility if carrier allocation based, for example, on load or other real time demands. Such a variable relationship could, for example, be provided by multiplexers and demultiplexers that may be controlled to distribute the inputs to and outputs from the frequency conversion circuits to differing ones of the hybrid circuits 400, the cable television termination circuits 402 and the wireless termination circuit 802 for central office nodes 302 and 702 or the hybrids 516, combiner splitters 520 and/or combiner splitters 920 for the remote location nodes 304 and 704. Such frequency allocations could be individually negotiated between the central office nodes and the remote location nodes and/or could be specified by the central office nodes, for example, utilizing a frequency allocation table that is transmitted to the remote location node.

Furthermore, while embodiments of the present invention have been described with reference to bi-directional communications, in particular embodiments of the present invention, bi-directional communications for the cable television signals need not be provided. Thus, for example, network access may be provided by the DSL communications and/or wireless network communications and television programming may be provided by the cable television signals such that cable television signals are only transmitted to customer premises. Such a system could, for example, utilize DSL communications in lieu of upstream cable television communications to, for example, request pay-per-view programming, activate and/or other wise provision a cable television STB or other such functions typically provided by conventional upstream communications in a cable television system.

In particular embodiments of the present invention, the remote nodes 304, 704 illustrated in FIG. 4 and/or 8 can be considered as two different types of equipment with similar functionality, a Node R being the fiber node deployed in the remote terminal/cabinet collocated with the DLC/NG-DLC and a Node L being deployed at a point closer to the customer premise and at some distance from DLC/NG-DLC.

The combined Node R/L or remote node is connected to the central office node via fiber, the DLC/NG-DLC via copper to support the telephony services and to the customer premise via copper, coax and to a mobile terminal through GSM, CDMA, W-CDMA or OFDM. The central office and remote nodes can be considered as supporting xDSL connections, analog and digital video, DOCSIS, and wireless transparently across a fiber network taking the modulated signal and using SCM as opposed to terminating the physical connection of each technology separately and multiplexing at an alternative layer, for instance at an IP, ATM or TDM layer.

Cost advantages of use of embodiments of the present invention may be achieved over current and proposed deployments of NG-DLC and OLTs/ONUs is based on the reduced complexity of the equipment, such as the central office and remote nodes. Furthermore, there may be no need for a remote DSLAM or the xDSL modems to be deployed in the remote terminals.

In addition to the reduced complexity of the equipment, an operations cost saving associated with service activation and provisioning may also be achieved by avoiding the need for a dispatch to deploy hardware at remote terminals, once the remote node is installed. A cost advantage may also come from the reduced impact of customer chum, on truck rolls and stranded assets in the remote sites, specifically since the incremental hardware required to support a customer can be installed at the central office/head end and can be reused for other customers.

Embodiments of the present invention also may provide LECs with an opportunity to deploy video services in selective markets through an IP-based transport connection and controls through xDSL, or even using the same video platform as a cable company.

Embodiments of the present invention may also overcome the length limitations of the copper plant without a significant investment in remote terminals, since the xDSL connection from the CO based DSLAM to the customer's xDSL modem, is supported transparently through the fiber connection.

Networks according to embodiments of the present invention may support xDSL (including ADSL, SHDSL and VDSL), DOCSIS cable modems, analog and digital video channels and HFR access for wireless access networks (any FDD wireless technology, including GSM, CDMA-cdmaOne and CDMA-2000, W-CDMA, specifically UMTS and OFDM).

Embodiments of the present invention also may be utilized to meet the stated objectives of the EURESCOM project focused on Full Access Networks (FANs) (see e.g., EURESCOM Project P 1117, “Future Access Networks” and Exp (Telecom Italia Lab), “Future All IP-based Access Networks”, Vol. 2, No. 2, July 2002).

Particular embodiments of the present invention may provide an alternative solution for broadband access and connectivity with significantly less complexity than FSAN, BPON and APON-based networks. Furthermore, embodiments of the present invention may push the complexity of the access network equipment to the central office and the customer's equipment, reducing the cost of the equipment deployed in the access network and outside plant. Furthermore, DSLAM functionality can be centrally located in COs, with higher density, supporting a pool of ADSL, VDSL, SHDSL and other xDSL modem technologies. Dependence on equipping remote terminals and cabinets with xDSL modems to increase loop qualification rates may also be removed. An installed base of copper plant, the DLC and local switch based infrastructure already installed by the LECs may be leveraged with collocation of the Node R at the remote terminals/cabinets.

Embodiments of the present invention may also enable the coexistence of xDSL, DOCSIS, analog and digital video and wireless through the same common access network platform, with minimal disruption to existing LEC telephony infrastructure. Video may also be overlayed via SCM as an alternative to supporting VOD via the IP layer through ADSL and VDSL. Embodiments of the present invention may also enable deployment of RAU in a wireless access network, as opposed to the completely equipped BTS and Node B bases stations at the cell sites, reducing complexity of the equipment deployed at the cell sites. This also facilitates dynamic carrier allocation and may reduce the cost of the equipment deployed at the cell site.

Embodiments of the present invention may also enable a fiber deep network evolution alternative to FTTx with focused deployment, while continuing to leverage the existing telephony based network, particularly with the deployment of Node Ls. Embodiments of the present invention could also support an Ethernet based connection from the CO without the need to have an ATM layer and the unnecessary overhead, enabling a more 1P-based access network.

The tradeoff for reducing the complexity in the access network is that there is reduced statistical gain of customer traffic and concentration of broadband services in the plant, specifically above the transport layer, either at the IP, ATM or MAC layer. Since each subscriber and customer premise has a dedicated “channel” through the hybrid fiber access network from the CO, there may be a concern with respect to the impact on fiber capacity in the access network. Channel planning for networks according to embodiments of the present invention may provide for maximization of the utilization of the available capacity. For example, multiple channels, such as 200 kHz wireless channels may be combined on a single SCM channel, such as a 6 MHz SCM channel. Furthermore combinations of channels could also be combined so as to provide efficient packing of DSL, cable television and/or wireless networking channels onto the SCM channels. Furthermore, in order to improve the utilization of the fiber, D-WDM can be used to combine the SCM signals between the central office and remote nodes.

While embodiments of the present invention have been described with reference to primarily hardware embodiments, as will be appreciated by those of skill in the art in light of the present disclosure, the present invention may also be embodied as combinations of hardware and software. For example, the central office node and remote location node may include a digital signal processor and the SCM, DSL, cable television and/or wireless networking signals may be converted to the digital domain, processed in the digital domain and then returned to the analog domain for transmission. Thus, the blocks of the diagram may provide functions carried out by computer program code embodied in a computer readable medium that, when combined with a processor, provide a circuit for carrying out the operations of the block or blocks.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A hybrid communication system comprising:
an analog fiber optic distribution system from a central office to a remote location associated with customer premises;
a central office node located at the central office and configured to transmit digital subscriber loop (DSL) and cable television signals on the analog fiber optic distribution system and convert received transmissions from the analog fiber optic distribution system to DSL signals; and
a remote node located at the remote location and configured to convert received transmissions from the analog fiber optic distribution system to respective DSL signals for transmission over a copper distribution system to customer premises and to cable television signals for transmission over a coaxial cable distribution system to customer premises and further configured to transmit DSL loop signals received from the copper distribution system over the analog fiber optic distribution system.

2. The hybrid communication system according to claim 1, wherein the central office node is further configured to convert received transmission from the analog fiber optic distribution system of cable television signals; and
wherein the remote node is further configured to transmit cable television signals from the cable television distribution system over the analog fiber optic distribution system.

3. The hybrid communication system according to claim 2, wherein the central office node comprises:
a plurality of frequency up converter circuits configured to convert respective DSL and cable television signals to a corresponding one of carrier frequency associated with the analog fiber optic distribution system;
a combiner circuit configured to receive the up converted DSL and cable television signals and combine the received up converted signals to provide an analog fiber optic signal corresponding to the received up converted signals;
a fiber optic transmitter circuit operably associated with the combiner circuit and configured to transmit the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective DSL and cable television signals based on corresponding carrier frequencies associated with the analog fiber optic distribution system.

4. The system of claim 3, wherein the central office node further comprises:
a plurality of hybrid circuits configured to provide DSL signals received from a copper-based infrastructure to corresponding ones of the frequency up converter circuits and receive DSL signals from corresponding ones of the frequency down converter circuits and provide the DSL signals received from the frequency down converter circuits to the copper-based infrastructure; and
a plurality of coaxial splitter/combiner circuits configured to provide cable television signals received from a cable television coaxial cable infrastructure to corresponding ones of the frequency up converter circuits and receive cable television signals from corresponding ones of the frequency down converter circuits and provide the cable television signals received from the frequency down converter circuits to the cable television coaxial cable infrastructure.

5. The system of claim 3, wherein the central office node further comprises a splitter configured to receive the analog fiber optic signal from the fiber optic receiver circuit and to provide the received analog fiber optic signal to the plurality of frequency down converter circuits.

6. The hybrid communication system according to claim 2, wherein the remote node comprises:
a plurality of frequency up converter circuits configured to convert respective DSL and cable television signals to a corresponding one of a carrier frequencies associated with the analog fiber optic distribution system;
a combiner circuit configured to receive the up converted DSL and cable television signals and combine the received up converted signals to provide an analog fiber optic signal corresponding to the received up converted signals;
a fiber optic transmitter circuit operably associated with the combiner circuit and configured to transmit the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective DSL and cable television signals based on corresponding carrier frequencies associated with the analog fiber optic distribution system.

7. The system of claim 6, wherein the remote node further comprises:
a plurality of hybrid circuits configured to provide DSL signals received from a copper-based infrastructure to corresponding ones of the frequency up converter circuits and receive DSL signals from corresponding ones of the frequency down converter circuits and provide the DSL signals received from the frequency down converter circuits to the copper-based infrastructure; and
a plurality of coaxial splitter/combiner circuits configured to provide cable television signals received from a cable television coaxial cable infrastructure to corresponding ones of the frequency up converter circuits and receive cable television signals from corresponding ones of the frequency down converter circuits and provide the cable television signals received from the frequency down converter circuits to the cable television coaxial cable infrastructure.

8. The system of claim 6, wherein the remote node further comprises a splitter configured to receive the analog fiber optic signal from the fiber optic receiver circuit and to provide the received analog fiber optic signal to the plurality of frequency down converter circuits.

9. The hybrid communication system according to claim 1, wherein the central office node is further configured to transmit wireless networking signals on the analog fiber optic distribution system and convert received transmissions from the analog fiber optic distribution system to wireless networking signals; and
wherein the remote node is further configured to transmit wireless networking signals received from a wireless networking distribution antenna over the analog fiber optic distribution system and convert received transmissions from the analog fiber optic distribution system to wireless networking signals for transmission by the wireless networking distribution antenna.

10. A hybrid communication system comprising:
an analog fiber optic distribution system from a central office to a remote location associated with customer premises;
a central office node located at the central office and configured to transmit digital subscriber loop (DSL) and wireless networking signals on the analog fiber optic distribution system and convert received transmissions from the analog fiber optic distribution system to DSL or wireless networking signals; and
a remote node located at the remote location and configured to transmit wireless networking signals received from a wireless networking distribution antenna and DSL signals received from a copper distribution system to customer premises over the analog fiber optic distribution system and convert received transmissions from the analog fiber optic distribution system to wireless networking signals for transmission by the wireless networking distribution antenna and DSL signals for transmission on the copper distribution system.

11. The hybrid communication system according to claim 10, wherein the central office node comprises:
a plurality of frequency up converter circuits configured to convert respective wireless networking signals to a corresponding one of a carrier frequencies associated with the analog fiber optic distribution system;
a combiner circuit configured to receive the up converted wireless networking signals and combine the received up converted signals to provide an analog fiber optic signal corresponding to the received up converted signals;
a fiber optic transmitter circuit operably associated with the combiner circuit and configured to transmit the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective wireless networking signals based on corresponding carrier frequencies associated with the analog fiber optic distribution system.

12. The system of claim 11, wherein the central office node further comprises a plurality of wireless networking termination circuits configured to provide wireless networking signals received from a wireless networking infrastructure to corresponding ones of the frequency up converter circuits and receive wireless networking signals from corresponding ones of the frequency down converter circuits and provide the wireless networking signals received from the frequency down converter circuits to the wireless networking infrastructure.

13. The system of claim 11, wherein the central office node further comprises a splitter configured receive the analog fiber optic signal from the fiber optic receiver circuit and to provide the received analog fiber optic signal to the plurality of frequency down converter circuits.

14. The hybrid communication system according to claim 10, wherein the remote node comprises:
a plurality of frequency up converter circuits configured to convert respective wireless networking signals to a corresponding one of a carrier frequencies associated with the analog fiber optic distribution system;
a combiner circuit configured to receive the up converted wireless networking signals and combine the received up converted signals to provide an analog fiber optic signal corresponding to the received up converted signals;
a fiber optic transmitter circuit operably associated with the combiner circuit for transmitting the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective wireless networking signals based on corresponding carrier frequencies associated with the analog fiber optic distribution system.

15. The system of claim 14, wherein the remote node further comprises a plurality of wireless networking termination circuits configured to provide wireless networking signals received from a wireless networking infrastructure to corresponding ones of the frequency up converter circuits and receive wireless networking signals from corresponding ones of the frequency down converter circuits and provide the wireless networking signals received from the frequency down converter circuits to the wireless networking infrastructure.

16. The system of claim 14, wherein the remote node further comprises a splitter configured receive the analog fiber optic signal from the fiber optic receiver circuit and to provide the received analog fiber optic signal to the plurality of frequency down converter circuits.

17. A hybrid communication system comprising:
an analog fiber optic distribution system from a central office to a remote location associated with customer premises;
a central office node located at the central office and configured to transmit at least two of digital subscriber loop (DSL), cable television and/or wireless networking signals on the analog fiber optic distribution system and convert received transmissions from the analog fiber optic distribution system to the at least two of DSL, cable television and/or wireless networking signals; and
a remote node located at the remote location and configured to transmit at least two of wireless networking signals received from a wireless networking distribution antenna, cable television signals received from a cable television distribution system and/or DSL signals received from a copper distribution system to customer premises over the analog fiber optic distribution system and convert received transmissions from the analog fiber optic distribution system to the at least two of wireless networking signals, cable television signals and/or DSL signals.

18. The hybrid communication system according to claim 17, wherein the central office node comprises:
a plurality of frequency up converter circuits configured to convert respective ones of the at least two of wireless networking signals, cable television signals and/or DSL signals to a corresponding one of a carrier frequencies associated with the analog fiber optic distribution system;
a combiner circuit configured to receive the up converted signals and combine the received up converted signals to provide an analog fiber optic signal corresponding to the received up converted signals;
a fiber optic transmitter circuit operably associated with the combiner circuit and configured to transmit the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective ones of the at least two of wireless networking signals, cable television signals and/or DSL signals based on corresponding carrier frequencies associated with the analog fiber optic distribution system.

19. The hybrid communication system according to claim 17, wherein the remote node comprises:
a plurality of frequency up converter circuits configured to convert respective ones of the at least two of wireless networking signals, cable television signals and/or DSL signals to a corresponding one of a carrier frequencies associated with the analog fiber optic distribution system;
a combiner circuit configured to receive the up converted signals and combine the received up converted signals to provide an analog fiber optic signal corresponding to the received up converted signals;
a fiber optic transmitter circuit operably associated with the combiner circuit for transmitting the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective ones of the at least two of wireless networking signals, cable television signals and/or DSL signals based on corresponding carrier frequencies associated with the analog fiber optic distribution system.

20. A method of communicating cable television and digital subscriber loop signals between a central office and a remote location associated with customer premises, comprising:
mutliplexing at least two of cable television signals, wireless network signals and/or digital subscriber loop signals on an analog fiber optic distribution system between the central office and the remote location; and
demultiplexing the at least two of cable television signals, wireless networking signals and/or digital subscriber loop signals from the analog fiber optic distribution system between the central office and the remote location.

21. The method of claim 20, wherein multiplexing digital subscriber loop signals further comprises filtering digital subscriber loop signals to fit within a bandwith allocation of a channel of the analog fiber optic distribution system.

22. The method of claim 20, wherein the at least two of cable television signals, wireless networking signals and/or digital subscriber loop signals comprises cable television signals, wireless networking signals and digital subscriber loop signals.

23. A system for communicating cable television and digital subscriber loop signals between a central office and a remote location associated with customer premises, comprising:
means for mutliplexing at least two of cable television signals, wireless networking signals and/or digital subscriber loop signals on an analog fiber optic distribution system between the central office and the remote location; and
means for demultiplexing the at least two of cable television signals, wireless networking signals and/or digital subscriber loop signals from the analog fiber optic distribution system between the central office and the remote location.

24. The system of claim 23, wherein means for multiplexing digital subscriber loop signals further comprises means for filtering digital subscriber loop signals to fit within a bandwidth allocation of a channel of the analog fiber optic distribution system.

25. The system of claim 23, wherein the at least two of cable television signals, wireless networking signals and/or digital subscriber loop signals comprises cable television signals, wireless networking signals and digital subscriber loop signals.

26. A communication node for use in a hybrid communication system, comprising:
a plurality of frequency up converter circuits configured to convert respective DSL and cable television signals to a corresponding one of a carrier frequencies associated with an analog fiber optic distribution system;
a combiner circuit configured to receive the up converted DSL and cable television signals and combine the received up converted signals to provide an analog fiber optic signal corresponding to the received up converted signals;
a fiber optic transmitter circuit operably associated with the combiner circuit for transmitting the analog fiber optic signal on the analog fiber optic distribution system;
a fiber optic receiver circuit configured to receive an analog fiber optic signal from the analog fiber optic distribution system; and
a plurality of frequency down converter circuits configured to convert the received analog fiber optic signal to respective DSL and cable television signals based on corresponding carrier frequencies associated with the analog fiber optic distribution system.

27. The communication node of claim 26, further comprising:
a plurality of hybrid circuits configured to provide DSL signals received from a copper-based infrastructure to corresponding ones of the frequency up converter circuits and receive DSL signals from corresponding ones of the frequency down converter circuits and provide the DSL signals received from the frequency down converter circuits to the copper-based infrastructure; and
a plurality of coaxial splitter/combiner circuits configured to provide cable television signals received from a cable television coaxial cable infrastructure to corresponding ones of the frequency up converter circuits and receive cable television signals from corresponding ones of the frequency down converter circuits and provide the cable television signals received from the frequency down converter circuits to the cable television coaxial cable infrastructure.

28. The communication node of claim 26, further comprising a splitter configured to receive the analog fiber optic signal from the fiber optic receiver circuit and to provide the received analog fiber optic signal to the plurality of frequency down converter circuits.
